(19) United States
(12) Patent Application Publication
(10) Pub. No.: US 2013/0009765 A1
(43) Pub. Date: Jan. 10, 2013

(54) METHODS AND SYSTEMS FOR DETERMINING A RANGE LIMIT BASED ON A VEHICLE'S ENERGY SOURCE STATUS

(75) Inventors: Dale Gilman, Beverly Hills, MI (US); Paul Aldighieri, Grosse Pointe Farms, MI (US); Leann Kridner, Canton, MI (US); Ryan Skaff, Farmington Hills, MI (US); Vilay Patel, Canton, MI (US); Stephen Jay Orris, New Boston, MI (US)

(73) Assignee: FORD GLOBAL TECHNOLOGIES, LLC, Dearborn, MI (US)

(21) Appl. No.: 13/177,172

(22) Filed: Jul. 6, 2011

(51) Int. Cl. G06F 7/00; B60Q 1/00

(52) U.S. Cl. 340/455; 701/1

(57) ABSTRACT

Various embodiments relate to determining a range limit for a vehicle based on the vehicle's energy source status. An energy status of a vehicle and a location of an energizing station for the vehicle may be received at a computer. The computer may be operable to communicate with one or more vehicle systems. A travel distance value from a current location of the vehicle to the location of the energizing station may be calculated. Additionally, a range limit value for the vehicle based on the energy source status and the travel distance value may be calculated. Based on the range limit value, one or more range values of the vehicle with respect to returning to the energizing station may be determined.

### TECHNICAL FIELD

Various embodiments relate to methods and systems for advising a vehicle occupant to refuel a vehicle, e.g., to visit a charging station to charge the vehicle. In some embodiments, one or more alerts to the vehicle occupant may indicate that a range limit for the vehicle has been reached.

### BACKGROUND

As the use of electric vehicles becomes more pervasive, fuel stations for these electric vehicles on public roadways are comparatively scarce. Typically, owners of an electric vehicle will have a charging station at their home and, less frequently, at an office.

Generally, electric vehicles have limited and variable range, both of which which can be affected by weather, traffic and the like. Further, electric vehicles typically take a much longer time to charge than its gasoline-fueled counterpart.

Various implementations for notifying a vehicle occupant about a range limit have been employed. For example, U.S. Publication No. 2010/0094496 to Hershkovitz et al. discloses a system and method for managing energy usage in an electric vehicle. According to the Hershkovitz publication, a charge level of at least one battery of the electric vehicle is received. A current location of the electric vehicle is received. A theoretical maximum range of the electric vehicle is determined based on the current location of the electric vehicle and the charge level of the at least one battery of the electric vehicle. Further, an energy plan for the electric vehicle is generated.

### SUMMARY

One aspect includes a system for managing usage of an energy source in a vehicle. The system may include at least one computer operable to communicate with one or more vehicle-based systems. The computer may be configured to receive an energy status of a vehicle. The energy status may be defined as a distance value to empty. Further, the at least one computer may be configured to receive a location of an energizing station for the vehicle.

The at least one computer may be configured to calculate a travel distance value from a current location of the vehicle to the location of the energizing station. The at least one computer may be also configured to calculate a range limit value for the vehicle based on the distance value to empty and the travel distance value.

The at least one computer may be configured to determine one or more range values of the vehicle with respect to returning to the energizing station based on the range limit value.

In some embodiments, the at least one computer may be configured to monitor for a depletion of the one or more range values. The at least one computer may be configured to determine a new range value of the vehicle with respect to returning to the energizing station based on the range limit value upon depletion.

In some embodiments, the one or more range values may be determined by splitting (e.g., by half) a value difference between the travel distance value and the distance value to empty. In some embodiments, one or more range buffer values may be included in determining the one or more range values.

In some embodiments, the at least one computer may be configured to determine a direction of travel of the vehicle with respect to the energizing station. Further, the at least one computer may be configured to determine one or more range values of the vehicle with respect to returning to the energizing station based on the range limit value and the direction of travel.

In some embodiments, the at least one computer may be configured to determine the one or more range values of the vehicle when the distance value to empty is greater than the travel distance value. Further, the at least one computer may be configured to repeatedly determine the one or more range values of the vehicle as long as the distance value to empty is greater than the travel distance value.

In some embodiments, the at least one computer may be configured to repeatedly determine the one or more range values of the vehicle until the travel distance value is equal to the distance value to empty or the calculated range value is equal to or near equal to a zero range value.

Another aspect may include a computer-program product for managing usage of an energy source in a vehicle. The computer-program product may be executing on a computer readable medium. The computer-program product may include instructions for receiving a charge status of a vehicle. Further instructions may be for receiving a location of a charge station for the vehicle.

The computer-program product may include instructions for calculating a travel distance value between a current location of the vehicle and the location of the charge station. Additional instructions may be for calculating one or more range values for the vehicle based on the charge status and the travel distance value.

The computer-program product may include instructions for determining a range limit value based on the one or more calculated range values. A notification may be output in the vehicle that an available charge of the vehicle is equal to or near equal to the range limit value.

Another aspect may include an apparatus configured to receive a distance to empty (DTE) value and a location of a charging station for a vehicle. The apparatus may be configured to calculate a travel distance value between the vehicle's current location and the charging station location. The apparatus may be also configured to calculate a range limit value based on the DTE and the travel distance value. The apparatus may be configured to determine range values for returning to the charging station based on the range limit value.

In some embodiments, the apparatus may be further configured to, based on the range values, identify a direction of travel of the vehicle with respect to the charging station. The direction of travel may be toward the charging station or away from the charging station.

These and other aspects will be better understood in view of the attached drawings and the following detailed description.

### BRIEF DESCRIPTION OF THE DRAWINGS

The figures identified below are illustrative of some embodiments of the invention. The figures are not intended to be limiting of the invention recited in the appended claims. The embodiments, both as to their organization and manner of operation, together with further object and advantages thereof, may best be understood with reference to the following description, taken in connection with the accompanying drawings, in which:

FIG. 1 is a simplified, exemplary schematic representation of a vehicle including an information display system according to one or more embodiments;

FIG. 2 is a process for alerting a vehicle occupant about the available range of a vehicle based on a battery charge;

FIG. 3 is a process for determining a range limit;

FIG. 4 is an graphical illustration of the range limit calculation of FIG. 3 as determined during vehicle operation; and

FIG. 5 is an exemplary information display according to the various embodiments.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Additionally, the disclosure and arrangement of the figures is non-limiting. Accordingly, the disclosure and arrangement of the figures may be modified or re-arranged to best fit a particular implementation of the various embodiments of the invention. Further, although illustrated and described in the context of a BEV, it is understood that the various embodiments may be implemented on other types of vehicles utilizing other variants of energy sources including, but not limited to, those powered by an internal combustion engine alone or additionally with one or more electric machines (e.g., HEVs, PHEVs, etc.).

Due to the limited range and the length of charge required for an electric vehicle, owners of such vehicle must typically plan well ahead for a trip, particularly if the journey is a long one. Unfortunately, this can also lead to range anxiety for many such owners for the fear of losing charge with no charging station in sight.

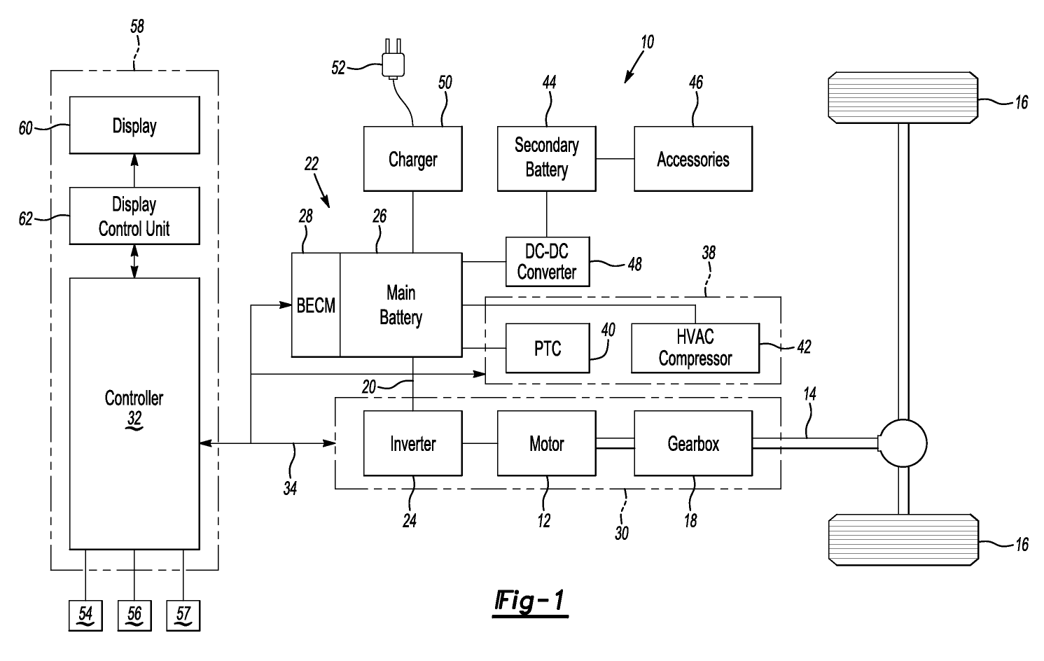

Referring now to the drawings, FIG. 1 is a simplified, exemplary schematic representation of a vehicle 10. As seen therein, the vehicle 10 may be a battery electric vehicle (BEV), which is an all-electric vehicle propelled by one or more electric machines without assistance from an internal combustion engine. The one or more electric machines of the vehicle 10 may include a traction motor 12. The motor 12 may output torque to a shaft 14, which may be connected to a first set of vehicle drive wheels, or primary drive wheels 16, through a gearbox 18. Other vehicles within the scope of the present application may have different electric machine arrangements, such as more than one traction motor. In the embodiment shown in FIG. 1, the traction motor 12 can be used as a motor to output torque to propel the vehicle 10. Alternatively, the motor 12 can also be used as a generator, outputting electrical power to a high voltage bus 20 and to an energy storage system 22 through an inverter 24.

The energy storage system 22 may include a main battery 26 and a battery energy control module (BECM) 28. The main battery 26 may be a high voltage battery that is capable of outputting electrical power to operate the motor 12. According to one or more embodiments, the main battery 26 may be a battery pack made up of several battery modules. Each battery module may contain a plurality of battery cells. The battery cells may be air cooled using existing vehicle cabin air. The battery cells may also be heated or cooled using a fluid coolant system. The BECM 28 may act as a controller for the main battery 26. The BECM 28 may also include an electronic monitoring system that manages temperature and state of charge of each of the battery cells. Other types of energy storage systems can be used with a vehicle, such as the vehicle 10. For example, a device such as a capacitor can be used, which, like a high voltage battery, is capable of both storing and outputting electrical energy. Alternatively, a device such as a fuel cell may be used in conjunction with a battery and/or capacitor to provide electrical power for the vehicle 10.

As shown in FIG. 1, the motor 12, the gearbox 18, and the inverter 24 may generally be referred to as a transmission 30. To control the components of the transmission 30, a vehicle control system, shown generally as a vehicle controller 32, may be provided. Although it is shown as a single controller, it may include multiple controllers that may be used to control multiple vehicle systems. For example, the controller 32 may be a vehicle system controller/powertrain control module (VSC/PCM). In this regard, the PCM portion of the VSC/PCM may be software embedded within the VSC/PCM, or it can be a separate hardware device.

A controller area network (CAN) 34 may allow the controller 32 to communicate with the transmission 30 and the BECM 28. Just as the main battery 26 includes a BECM, other devices controlled by the controller 32 may have their own controllers or sub-controllers. For example, the transmission 30 may include a transmission control module (TCM) (not shown), configured to coordinate control of specific components within the transmission 30, such as the motor 12 and/or the inverter 24. For instance, the TCM may include a motor controller. The motor controller may monitor, among other things, the position, speed, power consumption and temperature of the motor 12. Using this information and a throttle command by the driver, the motor controller and the inverter 24 may convert the direct current (DC) voltage supply by the main battery 26 into signals that can be used to drive the motor 12. Some or all of these various controllers can make up a control system, which, for reference purposes, may be the controller 32.

The vehicle 10 may also include a climate control system 38. The climate control system 38 may include both heating and cooling components. For instance, the climate control system 38 may include a high voltage positive temperature coefficient (PTC) electric heater and controller 40. The PTC 40 may be used to heat coolant that circulates to a passenger car heater. Heat from the PTC 40 may also be circulated to the main battery 26. The climate control system 38 may also include a high voltage electric HVAC compressor 42. Both the PTC 40 and the HVAC compressor 42 may draw electrical energy directly from the main battery 26. Moreover, the climate control system 38 may communicate with the controller 32. The on/off status of the climate control system 38 can be communicated to the controller 32, and can be based on, for example, the status of an operator actuated switch, or the automatic control of the climate control system 38 based on related functions such as window defrost.

In addition to the main battery 26, the vehicle 10 may include a separate, secondary battery 44, such as a typical 12-volt battery. The secondary battery 44 may be used to power the vehicle's various other accessories, headlights, and the like (collectively referred to herein as accessories 46). A DC-to-DC converter 48 may be electrically interposed between the main battery 26 and the secondary battery 44. The DC-to-DC converter 48 may allow the main battery 26 to charge the secondary battery 44.

The vehicle 10, which is shown as a BEV, may further include an alternating current (AC) charger 50 for charging the main battery 26 using an off-vehicle AC source. The AC charger 50 may include power electronics used to convert the off-vehicle AC source from an electrical power grid to the DC voltage required by the main battery 26, thereby charging the main battery 26 to its full state of charge. The AC charger 50 may be able to accommodate one or more conventional voltage sources from an off-vehicle electrical grid (e.g., 110 volt, 220 volt, etc.). The AC charger 50 may be connected to the off-vehicle electrical grid using an adaptor, shown schematically in FIG. 1 as a plug 52.

Also shown in FIG. 1 are simplified schematic representations of a braking system 54, an acceleration system 56, and a navigation system 57. The braking system 54 may include such things as a brake pedal, position sensors, pressure sensors, or some combination of the two, as well as a mechanical connection to the vehicle wheels, such as the primary drive wheels 16, to effect friction braking. The braking system 54 may also include a regenerative braking system, wherein braking energy may be captured and stored as electrical energy in the main battery 26. Similarly, the acceleration system 56 may include an accelerator pedal having one or more sensors, which, like the sensors in the braking system 54, may communicate information such as throttle input to the controller 32. The navigation system 57 may include a navigation display, a global positioning system (GPS) unit, a navigation controller and inputs for receiving destination information or other data from a driver. The navigation system may also communicate distance and/or location information associated with the vehicle 10, its target destinations, or other relevant GPS waypoints. The controller 32 may communicate with each individual vehicle system to monitor and control vehicle operation according to programmed algorithms and control logic. In this regard, the controller 32 may help manage the different energy sources available and the mechanical power being delivered to the wheels 16 in order to maximize the vehicle's range. The controller 32 may also communicate with a driver as well.

In addition to the foregoing, the vehicle 10 may include an information display system 58 to facilitate communications with a driver. As explained in detail below, the information display system 58 may provide relevant vehicle content to a driver of the vehicle 10 before, during or after operation. As shown in FIG. 1, the information display system 58 may include the controller 32 and an information display 60. The information display system 58 may also include its own control system, which, for reference purposes, may be a display control unit 62. The display control unit 62 may communicate with the controller 32 and may perform control functions on the information display 60, although the controller 32 may also function as the information display's control system. The controller 32 may be configured to receive input that relates to current operating conditions of the vehicle 10. For instance, the controller 32 may receive input signals from the BECM 28, the transmission 30 (e.g., motor 12 and/or inverter 24), the climate control system 38, the braking system 54, the acceleration system 56, or the like. The controller 32 may provide output to the display control unit 62 such that the information display 60 conveys energy consumption and range information, or other information relating to the operation of the vehicle 10 to a driver.

The information display 60 may be disposed within a dashboard (not shown) of the vehicle 10, such as an instrument panel or center console area. Moreover, the information display 60 may be part of another display system, such as the navigation system 57, or may be part of a dedicated information display system. The information display 60 may be a liquid crystal display (LCD), a plasma display, an organic light emitting display (OLED), or any other suitable display. The information display 60 may include a touch screen for receiving driver input associated with selected areas of the information display 60. The information display system 58 may also include one or more buttons (not shown), including hard keys or soft keys, located adjacent the information display 60 for effectuating driver input. Other operator inputs known to one of ordinary skill in the art may also be employed without departing from the scope of the present application.

Additionally or alternatively, a remote computing system, such as a PC, a nomadic device (such as, but not limited to, a cellular phone, smart phone, PDA, etc) or other device having a display may be used as an information display. Some or all of the processing of steps associated with illustrative embodiments disclosed herein may occur on the remote computing system as well.

Implementations of illustrative embodiments disclosed herein may be captured in programmed code stored on machine readable storage mediums, such as, but not limited to, computer disks, CDs, DVDs, hard disk drives, programmable memories, flash memories and other temporary or permanent memory sources. Execution of the programmed code may cause an executing processor to perform one or more of the methods described herein in an exemplary manner.

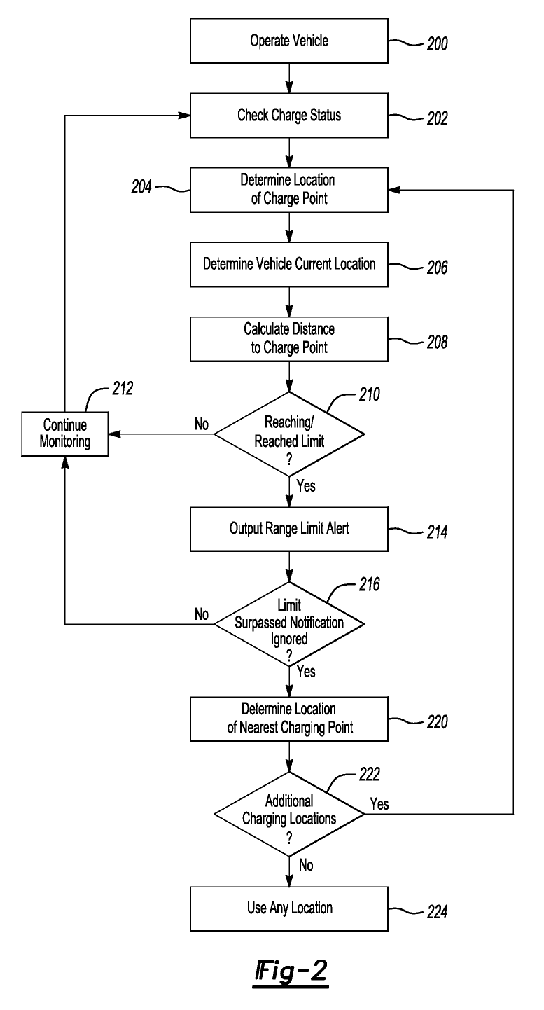

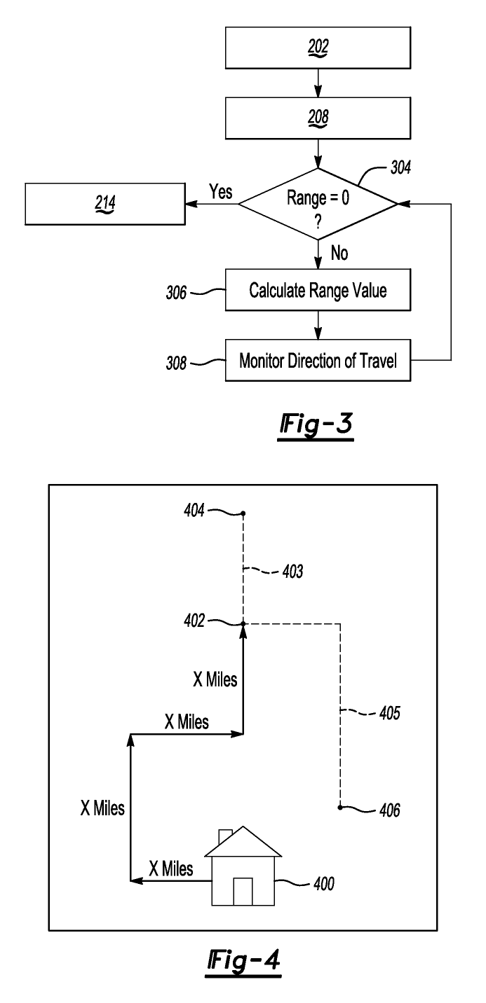

FIG. 2 illustrates a process for notifying a vehicle occupant of a range limit based on the charge level of the battery 26. The range calculation (as will be described with respect to FIG. 3) may be determined when the vehicle 10 is in operation which may include idle operation (after key-on) and/or when moving (block 200).

The charge status of the vehicle 10 may be at least one input to determine the range limit of the vehicle 10. To obtain the charge status, a determination may be made of the amount of charge remaining in the battery 26 which may be calculated in terms of a “distance to empty” (DTE). The distance may be calculated in any unit of distance measurement. Further, the terminology to describe the charge status is non-limiting; other terminology may be used according to the particular implementation of the invention. Accordingly, during vehicle operation, the charge status of the vehicle battery 26 may be checked or monitored (block 202).

The alerts provided to a vehicle occupant according to the various embodiments may be with respect to a range limit for returning from a current location to a vehicle charging point (e.g., a charging station). In some embodiments, the charging point may be one or more primary (e.g., default) charging stations. Unless otherwise noted, the description will refer to a primary charging station or charging point for explanation of the various embodiments. However, the term “primary” should not be construed as a limiting term nor should a “primary charging station” be construed as limiting the various embodiments.

The primary charging (or energizing) point may be a home, an office, school, or other like location. Generally, the primary charging point may be defined by the vehicle user, which may typically be the vehicle owner, and stored in a vehicle and/or user profile. The profile may be stored in local memory (e.g., at the vehicle). The location information may be input by the vehicle user via the navigation system 57 or input at a remote terminal (not shown) and transmitted to the vehicle 10 using a wired connection (e.g., USB). In this case, the vehicle 10 may be outfitted with an input port (e.g., a USB port) for receiving such data.

Therefore, additional inputs for determining the range limit may be the location of the primary charging point (block 204) and the current location of the vehicle (block 206). Based on the location (e.g., address) of the primary charging point as input by the vehicle owner, the location of the primary charge point may be determined by the GPS in the vehicle 10. Likewise, the current location of the vehicle 10 may also be determined by the GPS in the vehicle 10. In some embodiments, in addition to or as an alternative to using the current location of the vehicle 10, one or more destination points may be used as an input.

From the current location of the vehicle 10, the distance to the primary charging point may be determined (block 208). In some embodiments, a route from the current location to the primary charging point may be automatically casted by the navigation system 57 to calculate the distance. The distance between the current location and the primary charging point may be calculated as the “distance to the primary charging point” (DTPCP) and may be used in the calculation for determining a range alert value of the vehicle 10. The terminology to describe the range status is non-limiting; other terminology may be used according to the particular implementation of the invention. The range alert value may be the value that triggers an alert to the vehicle occupant that the vehicle 10 has only a range equal to the range alert value to return to the primary charging point based on the current vehicle charge (e.g., without an additional charging event). The alert may be a textual, graphical, or audible alert.

Additionally or alternatively, the range alert value may indicate a proximity to the range limit based on the vehicle charge. As a non-limiting example, there may be one or more range alert values that trigger an alert (e.g., warning alerts) before the maximum range limit has been reached (e.g., the maximum range value in order to return to the primary charging point from the current location). In this case, the maximum range limit alert may be associated with a different alert than the warning alert(s) to distinguish warnings from maximum range limit.

The primary charge point and/or the current location of the vehicle 10 may be displayed on the navigation display during vehicle operation. The primary charge point and/or the current location may be displayed graphically on a navigation map on the navigation display and/or displayed as text. In some embodiments, the driver may request the location of the primary charge point with respect to the current location at any time via one or more input requests such as tactile and/or verbal input request. Further, in some embodiments, in addition to outputting a range alert, the route from the current location to the primary charging point may also be displayed on the navigation system 57.

Of course, it is not necessary that the navigation system 57 output the alert(s) (e.g., during operation of the navigation system 57). For example, the alert(s) may additionally or alternatively be output in the vehicle 10 at the center stack (e.g., on the information display 60), instrument panel and/or through one or more vehicle speakers (not shown) (e.g., audible tone, beep, or spoken alert).

It is contemplated that the routing capabilities of the navigation system may be used to cast the route between the current location and the primary charging point for purposes of generating an alert with or without displaying any route on the navigation display. For example, the location data of the vehicle 10 and the primary charging point may be obtained, along with the routing data used by the navigation system, to cast the route. This route may not be generated for display on the navigation display.

Based on the battery charge and the distance to the primary charging point, a determination of whether the vehicle 10 is at or approaching the range limit (block 210) may be made for purposes of triggering one or more range limit alerts. The range limit may dynamically increase or decrease based on the direction of travel of the vehicle 10 with respect to the primary charging point (e.g., toward or away from the primary charging point). Consequently, the trigger for the range limit alert indicating that the vehicle 10 is at or approaching the range limit may dynamically change. At some point, the range limit may be small enough that the alert(s) may indicate to a vehicle occupant that any remaining charge be used to return to the primary charging point (or a charging point, in general). The calculation of the range values that determine a range limit will be described below with respect to FIG. 3.

If the limit has not been reached and/or the range is not near the limit range, the range of the vehicle may continue to be monitored (block 212). In this case, an alert may not be output at the vehicle 10 because such an alert may not be relevant or necessary. For example, a vehicle 10 may have a total range (e.g., distance to empty) of 40 miles, but the vehicle 10 is only 5 miles from the primary charging point. In this case, an alert may not be output because the vehicle can travel from and to the primary charging point within the total range and even the range limit. However, the battery charge level and the travel distance of the vehicle 10 may be monitored if the vehicle 10 continues to travel. It will be appreciated that the, while the example uses miles, other units of measurement may be used as desired in the particular implementation of the invention.

While the battery charge and travel distance is being monitored, the range of the vehicle 10 may be dynamically recalculated. In some embodiments, the vehicle range may be recalculated at certain intervals (e.g., based on time, distance, or both) during vehicle operation. For example, the range may be recalculated every “X” number of minutes. Alternatively or additionally, the range may be recalculated based on distance using the equation described with respect to and illustrated in FIG. 3. Ultimately, the range may be recalculated until the range limit is reached.

Referring back to block 210, if the vehicle range is at or near the limit, a notification or alert may be output at the vehicle 10 (block 214). In some embodiments, the notification may include the maximum distance that can be travelled based on the range limit.

Despite presentation of one or more range limit alerts, the range limit may still be exceeded or surpassed such that the vehicle 10 will not make it to the primary charge point (block 216). In such cases, alternative charging stations may be searched by the navigation system 57 (e.g., using a point-of-interest search) so that the vehicle 10 can be charged. The search may be performed manually or automatically. For example, when a notification or alert is output in the vehicle 10 that the range limit for reaching the primary charging point has been exceeded, a vehicle occupant may manually search for an alternative charging station as a point of interest (POI) search on the navigation system 57. Alternatively, the vehicle occupant may input an address of a location for a charging station, if known.

As an alternative to manually searching for charging station(s), the navigation system 57 may automatically begin a search once the range limit has been exceeded. When the range limit is exceeded, a signal or command may be automatically sent to the navigation system 57 to perform a point of interest search to search for a nearby charging station. The remaining charge of the battery 26 may be determinative of which charging stations may be accessible. Thus, once the limit has been exceeded, the remaining charge of the battery 26 may be determined and one or more charging stations in or around the current location of the vehicle 10 may be displayed.

Accordingly, if the range limit is exceeded, the nearest charging point may be searched and possibly identified (block 220). Otherwise, if the range limit is not exceeded, the range of the vehicle 10 may be continued to be monitored (block 212) as described above.

In some embodiments, alternative charging locations such as additional primary charging locations or one or more secondary charging locations may be provided by the vehicle owner and stored in memory, e.g., at the vehicle 10 in vehicle memory. As part of determining the nearest charging location after the range limit is exceeded, a determination may be made if there are any additional charging location(s) in memory (block 222). If not, the nearest charging location may be determined as described above (block 224). Otherwise, if there are additional charging locations provided by the vehicle user, then the additional charging location(s) may be searched and identified.

In some embodiments, the range limit may be calculated and the vehicle charge status may be determined (in terms of the range limit) for the additional charging location(s) as described above with respect to the primary charging location (block 222). The range limit alert for the primary location that may be output in the vehicle 10 may also indicate the range limit for the additional charge location(s). The range limit(s) for the additional location(s) may be displayed, for example, textually or graphically with an identification of the additional location(s) and the respective range limit(s).

FIG. 3 illustrates a process for calculating the range limit and calculating the charge range(s). As represented by block 202, the charge status of the battery may be checked (as described above). Further, as represented by block 208, the distance to the primary charging point may be calculated (as described above).

A value for a range limit alert may be defined as a range limit equal to 0 miles (or any other unit of distance measurement) as determined by one or more vehicle range calculations (block 304). In some embodiments, the range limit may be identified when, based on the charge, the vehicle's DTE equals the vehicle's DTPCP. In some embodiments, the range limit may be met if the range value is near a range of 0. As non-limiting examples, such range values may be 1, 2 or 3 miles. Other values and variants (e.g., fractional variants) of these values may be used without departing from the scope of the invention. In some embodiments, the range limit may be met if the range value is a fractional value (e.g., less than 1). For brevity, a range value of 0 will be used to describe and illustrate the various embodiments. Accordingly, if the range value is equal to 0, then the range limit alert (block 214) may be output in the vehicle 10.

Otherwise, the range of the vehicle 10 may be calculated (block 306) based on one or more calculation using the exemplary equation below. The range(s) may be calculated until the range limit is met.

Based on the direction of travel of the vehicle 10 (e.g., away or toward a primary charging point), the range value may dynamically change. In some embodiments, the direction of travel of the vehicle may be monitored (block 308) for calculating the range value (block 306). Various examples are provided below.

When the range is calculated and, based on this calculation, the DTE is greater than the DTPCP, the distance range for the vehicle may be recalculated until the range limit is reached. The range of the vehicle based on the charge of the battery 26 may be calculated by splitting a difference between the distance to empty and the distance to the primary charging point. The split may be half of the difference value. The following equation can be used to calculate vehicle range:

Vehicle Range=(DTE−DTPCP)/2 Equation 1

The following non-limiting example illustrates an application of the equation above to calculate the range distance and identify a range limit. The example is illustrated with respect to FIG. 4. In this example, DTE is 80 miles and DTPCP is 20 miles at location 402. As shown in FIG. 4, PCP is represented by reference number 400. It will be appreciated that the, while the examples use miles, other units of measurement may be used as desired in the particular implementation of the invention.

Range 1=(80 miles−20 miles)/2=30 miles.

Thus, at location 402, the vehicle can travel up to 30 miles in any direction. In some embodiments, an alert may be output in the vehicle 10 that the vehicle 10 has 30 miles of travel before the vehicle driver may have to head back to the PCP 400 (depending on the direction of travel as described below).

Once the 30 miles is depleted, the range may be recalculated to determine whether the vehicle 10 can travel an additional distance or should be driven back to the PCP 400. The determination may be dependent upon the vehicle's direction of travel (e.g., if the vehicle travelling away 403 from the PCP 400 or toward 405 the PCP 400).

Continuing with the example above, location 404 represents the termination of the 30 miles. As such, because the vehicle 10 is in a location away 403 from the PCP 400, a range limit alert may be output indicating that the vehicle should be returned to the PCP 400. Here, the DTE (50 miles) equals the DTPCP (50 miles) or the difference between the DTE and the DTPCP is 0 miles. Accordingly, the vehicle 10 cannot travel any additional distance except back to the PCP 400.

Location 406 represents the termination of the 30 miles, but the vehicle 10 has travelled 30 miles in the direction toward 405 the PCP 400. In this example, the location 406 is 10 miles from the PCP 400. As such, the DTE (50 miles) is greater than the DTPCP (10 miles) or the difference between the DTE and the DTPCP is still 40 miles. Accordingly, at this point, the range may be repeatedly recalculated (per the equation above) to obtain a new distance that can be travelled by the vehicle 10 until the range limit is met. Completing the calculation, the new range distance is 20 miles.

In some embodiments, a buffer value may be added the range limit calculation. Thus, in this embodiment, the vehicle range may be calculated as follows:

Vehicle Range=((DTE−DTPCP)/2)−Buffer value Equation 2

The buffer value may be any value representing an additional distance calculated into the range distance to create a distance range buffer. The buffer value may be predefined by the OEM or customized by the vehicle owner.

In this embodiment, as long as the DTE is greater than the DTPCP, the distance range for the vehicle may be calculated (and recalculated) until the range limit (as calculated using Equation 2) is reached. As described above, the range limit may be reached when the range value is around or equal to a range value of 0 miles (or any other unit of distance measurement) as determined by the vehicle range calculation.

The following non-limiting example illustrates an application of Equation 2 to calculate the range distance and identify a range limit. The example is illustrated with respect to FIG. 4. For consistency, the values used in the example above are used in this example (i.e., DTE is 80 miles and DTPCP is 20 miles at location 402). For this example, the buffer value is 2 miles. It will be appreciated that the buffer value is non-limiting such that any value may be used as desired for a particular implementation of the invention.

Range 1=((80 miles−20 miles)/2))−2 miles=28 miles.

Thus, at location 402, the vehicle can travel up to 28 miles in any direction. In some embodiments, an alert (e.g., an informational alert) may be output in the vehicle 10 that the vehicle 10 has 28 miles of travel before the vehicle driver may have to head back to the PCP 400 (depending on the direction of travel as described below).

Once the 28 miles is depleted, the range may be recalculated to determine whether the vehicle 10 can travel an additional distance or should be driven back to the PCP 400. The determination may be dependent upon the vehicle's direction of travel (e.g., if the vehicle travelling away 403 from the PCP 400 or toward 405 the PCP 400).

Continuing with the example above, location 404 represents the termination of the 28 miles at a location away 403 from the PCP 400. When the range distance is recalculate (at location 404), a range limit alert may be output indicating that the vehicle should be returned to the PCP 400 since, as shown below, the calculation results in a range of 0 miles:

At location 404, DTE=52 miles and DTPCP=48 miles.

Range=((52−48)/2)−2)=0 miles

Accordingly, the vehicle 10 cannot travel any additional distance except back to the PCP 400.

Location 406 represents the termination of the 28 miles, but the vehicle 10 has travelled 28 miles in the direction toward 405 the PCP 400. Again, for purposes of consistency with the above example, in this example, the location 406 is 10 miles from the PCP 400:

At location 406, DTE=52 miles and DTPCP=10 miles

Range=((52−10)/2)−2)=19 miles

As such, the DTE (52 miles) is greater than the DTPCP (10 miles) or the range, as calculated using Equation 2, is still 19 miles. Accordingly, at this point, the range may be repeatedly recalculated (per the equation above) to obtain a new distance that can be travelled by the vehicle 10 until the range limit is met.

In all embodiments, a range limit alert may be output at the range limit value (e.g., the difference between DTE and DTPCP is zero). In some embodiments, information alert(s) may also be output indicating that the limit is approaching. These alerts may represent the depletion of the previously calculated range and/or the calculation of the new range. In some embodiments, there may be distinguishing alerts between the information alerts and the range limit alert in order to indicate to the vehicle occupant(s) when the ultimate range limit has been reached.

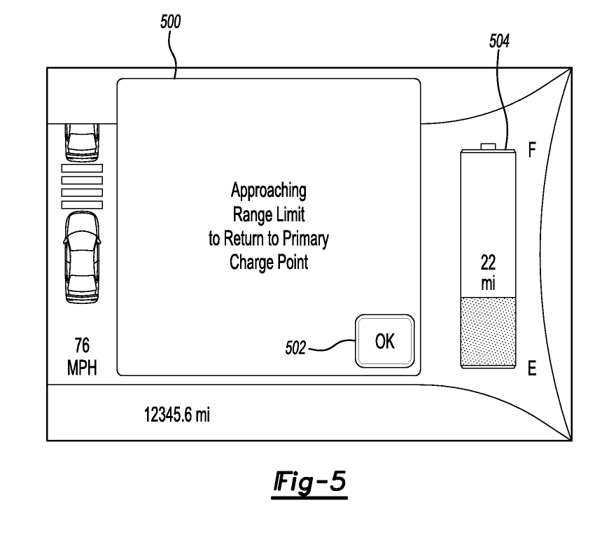

Referring to FIG. 5, an exemplary display that may be presented in the vehicle 10 (e.g., on display 58) is illustrated. The display may, in some embodiments, be a touch screen display.

The exemplary display illustrates an alert notifying a vehicle occupant that the range limit is approaching. However, the language of the notification is provided for illustration and is, therefore, non-limiting. In some embodiments, the notification illustrated in FIG. 5 may be an information alert (e.g., alerts presented at each calculation before the range limit is reached). In additional or alternative embodiments, FIG. 5 may illustrate the display for alerting a vehicle occupant of the range limit.

Further, the alert is presented as a graphical display. In this case, although it is not necessary, the notification is a pop-up message 500 on the display 58. In some embodiments, the alert may be presented as text. In additional or alternative embodiments, the alert(s) may be presented through one or more speakers in the vehicle.

A vehicle occupant may select button 502 (via touchscreen, a command button on the center stack or navigation system, or other like input) as acknowledgment of the notification. In some embodiments, upon selection of button 502, a navigation map may be displayed routing the vehicle back to the primary charging point, a navigation map may be displayed showing the current location of the vehicle, additional charging points may be displayed, and the like.

Graphic element 504 of the display may provide the total range available (e.g., the DTE). In some embodiments, the graphic element 504 may provide the range of the vehicle based on an equation above. In other embodiments, the graphic element 504 may provide the distance to a charging point (e.g., primary charging point or any additional charging point). Of course, graphic element 504 is represented as a battery, this is a non-limiting representation. Other representations may be used as desired according to the specific implementation of the invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for managing usage of an energy source in a vehicle, the system comprising:
at least one computer operable to communicate with one or more vehicle systems, the computer being configured to:
receive from at least one vehicle system an energy status of a vehicle defined as a distance value to empty;
receive from the at least one vehicle system a location of an energizing station for the vehicle;
calculate a travel distance value from a current location of the vehicle to the location of the energizing station;
calculate a range limit value for the vehicle based on the distance value to empty and the travel distance value; and
determine one or more range values of the vehicle with respect to returning to the energizing station based on the range limit value.

2. The system of claim 1 wherein the at least one computer is configured to:
monitor for a depletion of the one or more range values; and
upon depletion, determine a new range value of the vehicle with respect to returning to the energizing station based on the range limit value.

3. The system of claim 1 wherein the at least one computer configured to determine the one or more range values by splitting a value difference between the travel distance value and the distance value to empty.

4. The system of claim 3 wherein the splitting is by half.

5. The system of claim 3 wherein the at least one computer is configured to include one or more range buffer values to determine the one or more range values.

6. The system of claim 1 wherein the at least one computer is configured to:
determine a direction of travel of the vehicle with respect to the energizing station; and
determine one or more range values of the vehicle with respect to returning to the energizing station based on the range limit value and the direction of travel.

7. The system of claim 1 wherein the range values dynamically change based on a direction of travel of the vehicle.

8. The system of claim 1 wherein the at least one computer is configured to determine the one or more range values of the vehicle when the distance value to empty is greater than the travel distance value.

9. The system of claim 8 wherein the at least one computer is configured to repeatedly determine the one or more range values of the vehicle as long as the distance value to empty is greater than the travel distance value.

10. The system of claim 1 wherein the at least one computer is configured to repeatedly determine the one or more range values of the vehicle until the travel distance value is equal to the distance value to empty or the calculated range value is equal to or near equal to a zero range value.

11. The system of claim 1 wherein the at least one computer is further configured to output a notification when the range value is equal to or near equal to the range limit value.

12. The system of claim 11 wherein the notification includes an alert to return to the energizing station.

13. The system of claim 11 further comprising one or more displays in communication with the at least one computer for displaying the notification.

14. A computer-program product for managing usage of an energy source in a vehicle, the computer-program product executing on a computer readable medium and having instructions for:
receiving a charge status of a vehicle;
receiving a location of a charge station for the vehicle;
calculating a travel distance value between a current location of the vehicle and the location of the charge station;
calculating one or more range values for the vehicle based on the charge status and the travel distance value; and
determining a range limit value based on the one or more calculated range values for outputting a notification that an available charge of the vehicle is equal to or near equal to the range limit value.

15. The computer-program product of claim 14 further comprising instructions for outputting a notification for each calculated range value.

16. The computer-program product of claim 14 further comprising instructions for searching for an alternative charging station if the range limit value is exceeded.

17. The computer-program product of claim 14 further comprising instructions for
monitoring for a depletion of the one or more range values; and
upon depletion, determining a new range value of the vehicle with respect to returning to the charging station based on the range limit value.

18. An apparatus configured to:
receive a distance to empty (DTE) value and a location of a charging station for a vehicle;
calculate a travel distance value between the vehicle's current location and the charging station location;
calculate a range limit value based on the DTE and the travel distance value;
determine range values for returning to the charging station based on the range limit value.

19. The apparatus of claim 18 further configured to, based on the range values, identify a direction of travel of the vehicle with respect to the charging station.

20. The apparatus of claim 19 wherein the direction of travel is toward the charging station or away from the charging station.
